(19) United States
(12) Patent Application Publication
(10) Pub. No.: US 2005/0132211 A1
(43) Pub. Date: Jun. 16, 2005

(54) Java cryptographic engine to crypto acceleration integration

(76) Inventors: Mamoon Yunus, Newton, MA (US); Rizwan Mallal, Waltham, MA (US); Jesse D. Byler, Lancaster, MA (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/909,853

(22) Filed: Aug. 2, 2004

Related U.S. Application Data
(60) Provisional application No. 60/492,175, filed on Aug. 1, 2003.

(51) Int. Cl. H04L 9/00

(52) U.S. Cl. 713/189

(57) ABSTRACT

A networking appliance having a Java proxy engine that transparently offloads security functions into a cryptographic accelerator, thereby enabling rapid prototyping and platform independence, while increasing the speed of cryptographic and other security functions.

### CROSS-REFERENCE TO RELATED APPLICATIONS

This application claims priority to and incorporates by reference provisional patent application Ser. No. 60/492,175, filed Aug. 1, 2003.

### BACKGROUND OF THE INVENTION

1. Field of the Invention

This invention relates generally to public and private key cryptographic operations. More specifically, the present invention relates to increasing the speed and throughput of network traffic that requires processing of cryptographic functions before the network traffic can proceed to its intended destination.

2. Description of Related Art

The state of the art in cryptographic processing can be characterized by the process to be described as follows. Consider a network that includes a network appliance that intercepts network traffic in order to determine if security functions need to be applied to the before the network traffic is allowed to travel to its destination within the network. For example, an incoming message may include an attachment that is encrypted. The intercepted message may need to be decrypted and scanned for viruses before the message is sent on to its destination.

The encrypted message will generally be decrypted by a general purpose CPU that can perform this function. Other security functions that may be performed in this manner include encryption, decryption, verification, and signing functions that are associated with secured documents.

Disadvantageously, a general purpose CPU performing security functions is going to be a bottleneck to for network traffic that needs to be processed before the network traffic can be permitted to travel to its destination within the network. Furthermore, the C code that will be operating the network appliance and directing some of the security functions is not going to be easily upgradeable as security functions are improved, or more importantly, changed in the industry as improvements are implemented.

Accordingly, what is needed is a system for providing the security functions described above that is faster than the state of the art solution that uses a general purpose CPU for performing some of the security functions. It would be a further improvement to provide a means for more rapidly upgrading the software performing the security and network functions, thus enabling both rapid prototyping and deployment of improved security functions.

### BRIEF SUMMARY OF THE INVENTION

It is an object of the present invention to provide a network appliance that provides an integration module using both Java and C programming languages that includes a Java Cryptographic Engine (JCE) that would control offloading of at least a portion of security functions to a dedicated cryptographic accelerator.

It is another object to provide the network appliance that will transparently offload the security functions without modifying the application running in Java.

It is another object to provide the network appliance that includes a Java proxy engine that performs the transparent offloading of security functions.

It is another object to provide the network appliance that transparently offloads the security functions to a dedicated cryptographic hardware processor.

It is another object to provide the network appliance that transparently offloads the security functions to a dedicated cryptographic software module.

In a preferred embodiment, the present invention is a networking appliance having a Java proxy engine that transparently offloads security functions into a cryptographic accelerator, thereby enabling rapid prototyping and platform independence, while increasing the speed of cryptographic and other security functions.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of functional layers of operations that are arranged in accordance with the principles of the present invention.

FIG. 2 is a flowchart of the steps that can be performed in one embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a network appliance that intercepts network traffic. In the prior art, a proxy engine disposed and operating in the network appliance is written in C code. The proxy engine performs desired security functions for the SSL. These functions are CPU intensive, especially on a general purpose CPU.

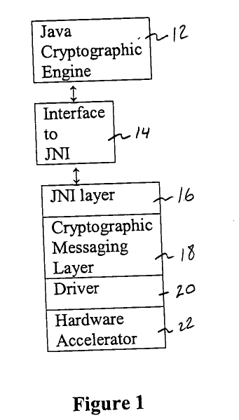

The present invention overcome several drawbacks to the prior art scenario described above. The advantages of the present invention will be described while referring to FIG. 1.

FIG. 1 is a block diagram of the basic components of the present invention. These components include a new Java Cryptographic Engine (JCE) 12, a Java Native Interface (JNI) 14, a JNI layer 16, a Cryptographic Messaging Layer 18, a Hardware Driver 20, and a Hardware Accelerator 22.

An example of the operation of these components of the present invention will be described using the example of performing public key operations on intercepted network traffic. Consider a network appliance that is operating either in an in-line mode where network traffic must pass through it to get to another side, or in a proxy mode. The goal of the present invention is to increase throughput of network traffic through the network appliance, especially when the network traffic must have a security process performed before the network traffic is permitted to continue on to its intended destination.

As stated before, network traffic is intercepted by a network appliance. In essence, the JCE is designed to transparently offload security functions that are intended for a general purpose CPU. This step has several important advantages over the prior art.

First, a Java coded proxy engine is performing the offloading operation. A Java coded proxy engine enables rapid prototyping of this function instead of having to use C code. Disadvantageously, C code typically requires compiling, and not all C code is compatible with other versions of C code. Thus, if different network appliances can be used to perform these offloading and security operations, the code would have to be rewritten for each different system.

Therefore, this step of offloading is performed at relatively high speeds. Accordingly, performance is not being sacrificed by using the Java coded proxy engine. Using a Java coded proxy engine means that the network appliance maintains its operating system and hardware platform independence because of the ubiquitous availability of Java virtual machines in operating systems that function with different hardware.

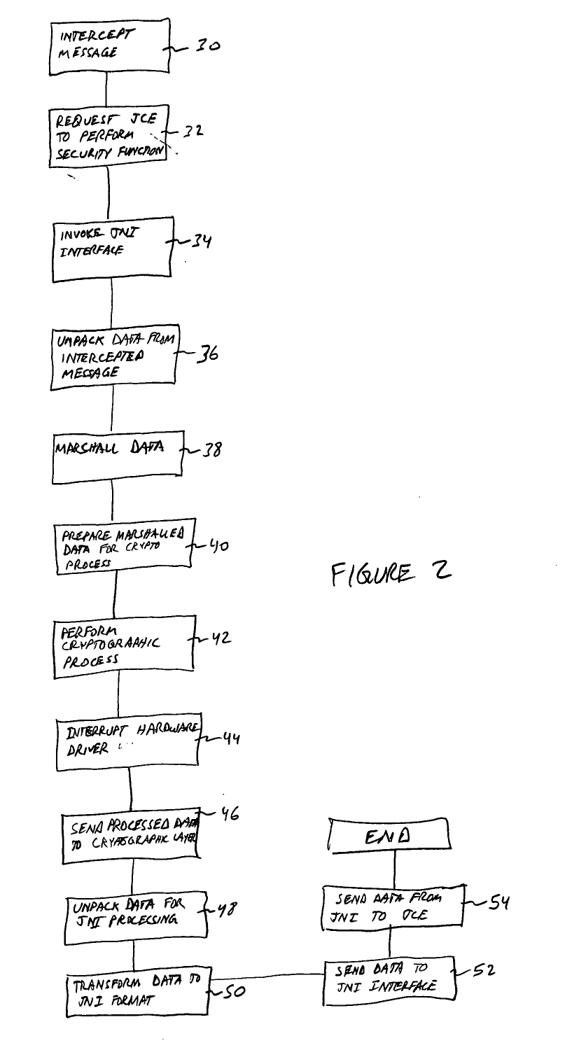

In this example of the present invention as shown in FIG. 2, the security function that is to be performed is a public key operation as understood by those skilled in the art. Specifically, a public key may be known by everyone, and a private key is known only to the recipient of the message. The public key will be assumed to have been used to encrypt a message that has been intercepted in step 1 (30) by the network appliance. It is assumed that it is known that the message contains a message that requires a cryptographic process to be performed.

After interception, a request enters the JCE layer 12 for a public key operation to be performed on data using, for example, the RSA cryptographic algorithm in step 2 (32). The next step 3 (34) is for Java Native Interface (JNI) hooks to be invoked through the Interface to JNI 14. In the present invention, the JNI hooks are only inserted in particular sections of the JCE when public key operations are to be offloaded. The JNI hooks provide an interface to a C interface library which is shown as the JNI layer 16.

The next step 4 (36) is for the JNI layer 16 to take the requests for public key operations from the layers above and unpack the data from the message so that the data can be manipulated by the C language.

After being unpacked, the data is marshaled by the Cryptographic Messaging layer 18 in step 5 (38). Data marshalling is required when passing the output parameters of a program written in one language as input to a program written in another language. In this case, the purpose of data marshalling is to gather data and transform it into a standard format. In order for an object to be moved around a network, it must be converted into a data stream that corresponds with the packet structure of the network transfer protocol.

After marshalling, the data is passed on to the Hardware Driver 20. The purpose of the Hardware Driver 20 is to prepare Hardware Accelerator 22 to perform the desired operation in step 6 (40). In this case, the Hardware Accelerator 22 is being prepared to perform decryption of the intercepted message.

Once the RSA decryption operation is performed in step 7 (42), the Hardware Driver 20 is interrupted by the Hardware Accelerator 22 in step 8 (44). The Hardware Driver 20 passes the decrypted data back to the Cryptographic Messaging Layer 18 in step 9 (46). The Cryptographic Messaging Layer 18 unpacks the decrypted data in raw C format in step 10 (48) for the JNI Layer 16 to transform to JNI format in step 11 (50) which the upper Java layers will understand. Once the JNI Interface 14 hooked to the JCE 12 receives the result in JNI format in step 12 (52), the JNI Interface 14 unpacks the decrypted data and sends the results to the JCE 12 in step 13 (54).

It should be understood that the sequence above is followed for any security functions that can be offloaded to a hardware accelerator, and is not limited to the example of RSA decryption described above.

It is envisioned that the Java and C proxy engines will be ported to a software platform on a desktop PC or a notebook PC running, for example, Windows 2000 or Windows XP. However, this should not be considered a limiting factor, and the present invention can be ported to other operating systems and other hardware platforms as well.

The advantages of the present invention over the prior art are substantial. The present invention is versatile because of its platform independence that is enabled by the use of the Java language. The offloading is transparent to operation of the network appliance. Use of the Java language inherently means that the prototyping of changes and improvements is rapid because of the ease of use of the Java language. Performance of the offloaded security functions is substantially increased because of hardware that is dedicated to the desired security functions, instead of using a general purpose CPU. Furthermore, high speed performance is maintained because of the use of the Java language.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for accelerating processing of security functions in a network, said method comprising the steps of:
1) intercepting data being transferred across the network;
2) determining that a security function to be performed can be offloaded for hardware acceleration;
3) utilizing a proxy engine to transparently offload the data; and
4) performing the security function in hardware.

2. The method as defined in claim 1 wherein the method of utilizing a proxy engine further comprises the step of utilizing a Java Cryptographic Engine (JCE) to transparently offload the data to be offloaded.

3. The method as defined in claim 2 wherein the method further comprises the step of entering a request in the JCE layer for a cryptographic function to be performed.

4. The method as defined in claim 3 wherein the method further comprises the step of invoking Java Native Interface (JNI) hooks to function as an interface to an operating system specific programming language interface library.

5. The method as defined in claim 4 wherein the method further comprises the step of invoking Java Native Interface (JNI) hooks in a JNI layer to function as an interface to a C programming language interface library.

6. The method as defined in claim 5 wherein the method further comprises the step of unpacking data from the intercepted message so that the data can be manipulated in the operating system specific programming language.

7. The method as defined in claim 6 wherein the method further comprises the step of marshalling the data so that the data can be transformed to a standard format.

8. The method as defined in claim 7 wherein the method further comprises the step of marshalling the data in a cryptographic messaging layer.

9. The method as defined in claim 8 wherein the method further comprises the step of marshalling the data so that the data can be transferred across a network having a specific network packet protocol.

10. The method as defined in claim 9 wherein the method further comprises the step of transferring the data to a hardware driver.

11. The method as defined in claim 10 wherein the method further comprises the step of using the hardware driver to prepare a hardware accelerator for receiving data to be cryptographically processed.

12. The method as defined in claim 11 wherein the method further comprises the step of transferring the data from the hardware driver to the hardware accelerator for cryptographic processing.

13. The method as defined in claim 12 wherein the method further comprises the step of selecting the type of cryptographic processing to be performed by the hardware accelerator from the group of cryptographic processes comprised of encrypting, decrypting, verification and signing.

14. The method as defined in claim 12 wherein the method further comprises the step of interrupting the hardware driver when the hardware accelerator has completed its cryptographic processing of the data so that the data can be transferred to a next destination.

15. The method as defined in claim 14 wherein the method further comprises the step of transferring the data from the hardware driver to the cryptographic messaging layer.

16. The method as defined in claim 15 wherein the method further comprises the step of unpacking the data.

17. The method as defined in claim 16 wherein the method further comprises the step of transferring the data from the cryptographic messaging layer to the JNI layer.

18. The method as defined in claim 17 wherein the method further comprises the step of transforming the data in the JNI layer.

19. The method as defined in claim 18 wherein the method further comprises the step of transferring the data from the JNI layer to the JCE layer through the JNI interface.

20. A system for accelerating processing of cryptographic functions in a network, said system comprised of:
a cryptographic hardware accelerator for performing cryptographic functions; and
a cryptographic proxy engine for offloading a message to the cryptographic hardware accelerator for cryptographic processing.

21. The system as defined in claim 20 wherein the system for accelerating processing of cryptographic functions is further comprised of a Java Cryptographic Engine (JCE) as the cryptographic hardware accelerator for transparently offloading the data to be offloaded.

22. The system as defined in claim 21 wherein the system for accelerating processing of cryptographic functions is further comprised of an interface to a Java Native Interface (JNI), wherein the JNI provides hooks to function as an interface to an operating system specific programming language interface library.

23. The system as defined in claim 22 wherein the system for accelerating processing of cryptographic functions is further comprised of a JNI layer for unpacking data from the intercepted message so that the data can be manipulated in the operating system specific programming language.

24. The system as defined in claim 23 wherein the system for accelerating processing of cryptographic functions is further comprised of cryptographic messaging layer, wherein the cryptographic messaging layer marshals the data so that the data can be transformed to a standard format.

25. The system as defined in claim 24 wherein the system for accelerating processing of cryptographic functions is further comprised of a hardware driver, wherein the hardware driver prepares the hardware accelerator to receive the data to be cryptographically processed.
